(19) United States
(12) Patent Application Publication
(10) Pub. No.: US 2005/0137995 A1
(43) Pub. Date: Jun. 23, 2005

(54) Method for regulating a thermodynamic process by means of neural networks

(75) Inventors: Franz Wintrich, Essen (DE); Volker Stephan, Hupstedt (DE); Dirk Tiedtke, Gelsenkirchen (DE)

Correspondence Address: WOMBLE CARLYLE SANDRIDGE & RICE, PLLC, P.O. BOX 7037, ATLANTA, GA, 30357-0037, US

(73) Assignee: Powitec Intelligent Technologies GmbH

(21) Appl. No.: 11/058,111

(22) Filed: Feb. 15, 2005

Related U.S. Application Data
(63) Continuation of application No. PCT/EP03/08599, filed on Aug. 2, 2003.

(30) Foreign Application Priority Data
Aug. 16, 2002 (EP) 02 018 426.3

(51) Int. Cl. G06N 3/08; G06F 15/18; G06N 3/10; G06F 15/00; G06F 17/00; G06N 5/02

(52) U.S. Cl. 706/48; 706/44

(57) ABSTRACT

In a method for regulating a thermodynamic process, in which process variables in the system are measured, predictions are calculated in a neural network on the basis of a trained, current process model and compared with optimization objectives and actions suitable for regulating the process are carried out in the system, at the same time the process is automatically analyzed and at least one new process model is formed, trained and compared with the current process model with respect to the predictions.

### CROSS-REFERENCE TO RELATED APPLICATION

The present application is a continuation of International Application PCT/EP2003/008599, which was filed Aug. 2, 2003, designates the U.S., and is incorporated herein by reference, in its entirety.

### TECHNICAL FIELD

The present invention relates to a method for regulating a thermodynamic process, in which process variables in the system are measured, predictions are calculated in a neural network on the basis of a trained, current process model and compared with optimization objectives, and actions suitable for regulating the process are carried out in the system.

### BACKGROUND OF THE INVENTION

In the case of a known method of the type described above in the Technical Field section, process variables that are difficult or expensive to measure are predicted by means of the process model in the neural network. To be able to follow changes of the process, three steps are carried out in a cycle, that is a process analysis to find a starting point for the process model, training of the neural network, and application of the process model for the prediction. This procedure is time-consuming and labor-intensive.

### BRIEF SUMMARY OF SOME ASPECTS OF THE INVENTION

The present invention is based on the object of providing improvements with regard to regulating a thermodynamic process, with the regulating being of the type in which process variables in the system are measured, predictions are calculated in a neural network on the basis of a trained, current process model and compared with optimization objectives, and actions suitable for regulating the process are carried out in the system. In accordance with one aspect of the present invention, at the same time as the regulating described in the immediately preceding sentence, the process is automatically analyzed and at least one new process model is formed, trained and compared with the current process model with respect to the predictions.

The fact that the process is automatically analyzed and at least one new process model is formed, trained and compared with the current process model with respect to predictions at the same time as normal regulating operation is in progress allows an adaptation of the model to a changed process to be achieved without increased expenditure on personnel. This completely automatic model adaptation preferably runs in the background, i.e. as a so-called batch job on the data-processing system, as opposed to running in the foreground, so that the expenditure of time is also no greater. A number of new process models with, for example, different topologies of the neural network and different numbers of training cycles allow an adaptation even to great changes of the process to be achieved.

### DETAILED DESCRIPTION OF THE INVENTION

Taking place in a cement kiln, as an example of a thermodynamic process, is a combustion process which is to be regulated in such a way that it has, on the one hand, a certain stability and, on the other hand, a certain plasticity, i.e. it adapts itself to the conditions, with certain optimization objectives having been set. The state in the cement kiln is described by various process variables, such as for example lime mass flow, air mass flow, or the like, some of which at the same time form manipulated variables. The state in the cement kiln is changed by actions, i.e. changes of manipulated variables. For online monitoring and regulation and predictions of future states of the cement kiln, a neural network is implemented on a data-processing system. The neural network defines a process model which indicates the change in the state as a reaction to actions and is independent of the optimization objectives. A quality function is used to perform a situation assessment, which assesses a specific, current state while taking the optimization objectives into consideration.

To be able to predict specific process variables, for example the FCaO value (which is also known as the clinker index and is a conventional measure of the quality of cement), to define the quality of the cement, in the case of a known method: first a process analysis is carried out in order to identify a function to determine the desired process variable, and then training of the neural network is performed with the process model based on the data obtained and finally the neural network is applied.

According to the present invention, on the other hand, a model adaptation is performed fully automatically in the background. For this purpose, first an automatic process analysis is carried out, providing a list of all the relevant process variables by means of methods of process identification (e.g., preferably various methods of process identification) in defined time cycles.

On this basis, various types of neural networks with various parameter constellations, such as learning rates and training cycles, number of layers, size of layers and other aspects of topology, parameters of the data processing (low-pass filter sizes or the like) are trained in automatic modeling and are verified on the respectively available database. The search for suitable network parameters can be realized in the high-dimensional parameter space by suitable optimization methods and search strategies (for example evolutionary methods).

If a process model which is better, i.e. works more accurately, than the model currently being used is found by the analysis and modeling, this new process model is used from then on.

This model adaptation provides an automatic adaptation to changing process properties of the respective plant, including major interventions, such as alterations or conversions, so that an adequate process model is ensured. Previously unconsidered process variables are also included if need be in the modeling.

1. A method for regulating a thermodynamic process in a system, the method comprising:
(a) regulating the process during a first period of time, with the regulating of the process during the first period of time including:
measuring process variables in the system,
calculating predictions in a neural network on the basis of a trained, current process model,
comparing the predictions of the current process model with optimization objectives, and
carrying out actions in the system, with the actions being for regulating the process, and the carrying out of the actions being responsive to the comparing of the calculated predictions with the optimization objectives; and
(b) automatically performing further actions during the first period of time, with the automatically performing of the further actions during the first period of time including:
analyzing the process,
forming and training at least one new process model, and
comparing the new process model to the current process model with respect to the predictions.

2. The method according to claim 1, further comprising:
determining whether predictions of the new process model are of greater accuracy than the predictions of the current process model; and
replacing the current process model with the new process model, if it is determined that the predictions of the new process model are of greater accuracy than the predictions of the current process model.

3. The method according to claim 1, wherein the analyzing of the process, the forming and training of the new process model, and the comparing of the new process model to the current process model run in background on a data-processing system.

4. The method according to claim 1, wherein the analyzing of the process takes place in a defined time cycle.

5. The method according claim 1, wherein the analyzing of the process includes determining model-relevant process variables.

6. The method according to claim 5, wherein the determining of the model-relevant process variables includes using optimization methods and search strategies.

7. The method according to claim 1, wherein the forming and training of the at least one new process model includes forming a plurality of new process models.

8. The method according to claim 7, wherein the new process models are formed for neural networks with different topologies and/or different data-processing parameters and/or different training.

9. The method according to claim 2, wherein the analyzing of the process, the forming and training of the new process model, and the comparing of the new process model to the current process model run in background on a data-processing system.

10. The method according to claim 2, wherein the analyzing of the process takes place in a defined time cycle.

11. The method according claim 2, wherein the analyzing of the process includes determining model-relevant process variables.

12. The method according to claim 2, wherein the forming and training of the at least one new process model includes forming a plurality of new process models.

13. The method according to claim 12, wherein the new process models are formed for neural networks with different topologies and/or different data-processing parameters and/or different training.

14. The method according to claim 2, wherein:
the analyzing of the process, the forming and training of the new process model, and the comparing of the new process model to the current process model run in background on a data-processing system;
the analyzing of the process takes place in a defined time cycle;
the analyzing of the process includes determining model-relevant process variables; and
the forming and training of the at least one new process model includes forming a plurality of new process models.

15. The method according to claim 2, further comprising regulating the process during a second period of time which follows the first period of time, with the regulating of the process during the second period including:
measuring process variables in the system,
calculating predictions in a neural network on the basis of the new process model,
comparing the predictions of the new process model with optimization objectives, and
carrying out, in the system, actions for regulating the process, with the carrying out of the actions during the second period being responsive to the second period's comparing of the predictions with the optimization objectives.

16. An apparatus for regulating a thermodynamic process in a system, the apparatus comprising:
sensors for measuring process variables in the system;
feedback mechanisms for carrying out actions in the system for regulating the process; and
a data-processing system for
(a) regulating the process during a first period of time, with the regulating of the process during the first period of time including
obtaining data from the sensors,
calculating predictions in a neural network on the basis of a trained, current process model,
comparing the predictions of the current process model with optimization objectives, and
instructing the feedback mechanisms with respect to the carrying out of the actions in the system, with the instructing of the feedback mechanisms being responsive to the comparing of the calculated predictions with the optimization objectives; and
(b) automatically performing further actions during the first period of time, with the automatically performing of the further actions during the first period of time including
analyzing the process,
forming and training at least one new process model, and
comparing the new process model to the current process model with respect to the predictions.

17. The apparatus according to claim 16, wherein the data-processing system is further for:
determining whether predictions of the new process model are of greater accuracy than the predictions of the current process model; and
replacing the current process model with the new process model, if it is determined that the predictions of the new process model are of greater accuracy than the predictions of the current process model.

18. The apparatus according to claim 16, wherein the analyzing of the process, the forming and training of the new process model, and the comparing of the new process model to the current process model run in background on the data-processing system.

19. The apparatus according to claim 16, wherein the forming and training of the at least one new process model includes forming a plurality of new process models.

20. The apparatus according to claim 17, wherein:
the analyzing of the process, the forming and training of the new process model, and the comparing of the new process model to the current process model run in background on the data-processing system;
the analyzing of the process takes place in a defined time cycle;
the analyzing of the process includes determining model-relevant process variables; and
the forming and training of the at least one new process model includes forming a plurality of new process models.
